(19) United States
(12) Patent Application Publication
(10) Pub. No.: US 2005/0066041 A1
(43) Pub. Date: Mar. 24, 2005

(54) Setting up a name resolution system for home-to-home communications

(76) Inventors: Kwan Wu Chin, Dulwich Hill (AU); Arthur Dimitrelis, Auburn (AU); John T. Judge, Coogee (AU); Andrew E. White, Matraville (AU)

Correspondence Address: MOTOROLA, INC., 1303 EAST ALGONQUIN ROAD, IL01/3RD, SCHAUMBURG, IL, 60196, US

(21) Appl. No.: 10/666,774

(22) Filed: Sep. 19, 2003

(51) Int. Cl. G06F 15/16

(52) U.S. Cl. 709/228; 709/238

(57) ABSTRACT

Methods, systems, and gateways are disclosed for automatically setting up a redirector of domain name system (DNS) name requests. A DNS setup packet is transmitted to a remote gateway via a tunnel of a virtual private network (VPN). The setup packet comprises a global name of a home network and a private address of a DNS server in the home network. A DNS setup reply packet is received from the remote gateway via the tunnel. The reply packet comprises a global name of another home network and a private address of a DNS server in the other home network. An application level gateway of the DNS server (DNS-ALG) in the home network is configured dependent upon the DNS setup reply packet to redirect DNS name requests for the global name of the other network to the DNS server in the other network. Methods, systems, and gateways are also disclosed for resolving a domain name request in a DNS.

### FIELD OF THE INVENTION

The present invention relates generally to communications networks and in particular to home networks using gateways.

### BACKGROUND ART OF THE INVENTION

A virtual private network (VPN) is a set of interconnected private networks (or home networks) using a private address space, as defined in RFC1918, or a site-scoped IPv6 address. Each home network belongs to a private name space, for example, “private.arpa” (or “local.arpa”) and also possibly one or more global domain names, for example “abc.xyz.com”. A gateway equipped with a domain name system (DNS) server, and possibly a DNS application level gateway (ALG), manages these domains.

Interconnecting one or more homes requires the synchronization of network information, e.g., addresses and names. Consistency is required, so that users continue to access existing and remote services located in other homes without interruption. For example, if the domain name “toaster.private.arpa” is valid in two or more homes, users are unable to access the host toaster unambiguously, unless the users use the toaster's underlying IP address provided the IP address of both hosts are unique. Moreover, renaming toaster to some other name causes inconvenience to users, who know the service by its previous name. This is especially a problem if the users have bookmarked the complete URL of the host.

Mechanisms have been proposed for establishing tunnels between two networks with the help of a third network. Such mechanisms assume that IP addresses and naming are manually configured.

Other mechanisms address VPN discovery and discovery of customer edge (CE) equipment that are part of a given VPN through a DNS. By querying the domain name, a CE is able to locate all CEs belonging to a given VPN, enabling the CE to form tunnels to other CEs belonging to a VPN. Customer edges in the same VPN belong to a well-known domain name (e.g., vpn1.vpn-net.net), and each CE registers its name in the DNS. To form a VPN, each CE queries the well-known domain name to obtain all IP addresses belonging to that domain. The CE then sets up a tunnel to each of the returned IP addresses.

Another mechanism proposes parsing a DNS request message, extracting the queried domain name, comparing the name to a list of domain names, and subsequently modifying the destination address of the DNS request message to the DNS server that is authoritative for the domain name. The modified DNS request message is then forwarded onwards to the new destination address.

Still another mechanism is known as a two-face DNS, which returns a suitable address depending on where a request originates from or which DNS server a host asks.

### SUMMARY OF THE INVENTION

In accordance with an aspect of the invention, there is provided a method of automatically setting up a redirector of domain name system (DNS) name requests. The method comprises the steps of: transmitting to a remote gateway via a tunnel of a virtual private network (VPN) a DNS setup packet comprising a global name of a home network, and a private address of the DNS server in the home network; receiving from the remote gateway via the tunnel a DNS setup reply packet comprising a global name of another home network and a private address of the DNS server in the other home network; and configuring an application level gateway of the DNS server (DNS-ALG) in the home network dependent upon the DNS setup reply packet to redirect DNS name requests for the global name of the other network to the DNS server in the other network.

The method may further comprise the step of extracting from the DNS setup reply packet the global name of the other home network, and the private address of the DNS server in the other home network.

The method may further comprise the step of resolving address conflicts between the home network and the other home network.

The method may further comprise the step of generating a DNS setup packet comprising the global name of the home network, and the private address of the DNS server in the home network.

The global names of the home network and the other home network may be fully qualified domain names (FQDNs).

The configuring step may comprise adding a redirect data structure in a configuration data structure of the DNS-ALG.

The method may further comprise the step of using a two-faced DNS system coupled to the DNS-ALG in the home network, the two-face DNS system comprising an internal side DNS server and an external side DNS server, the internal side DNS server resolving host names received via the VPN tunnel to corresponding private addresses.

In accordance with another aspect of the invention, there is provided a method of resolving a domain name request in a domain name system (DNS). The method comprises the steps of: determining if a domain name in a domain name request received by an application level gateway of a DNS (DNS-ALG) in a home network is not for the home network; and if the domain name request is determined to not be for the home network, forwarding the domain name request via a virtual private network (VPN) tunnel to an application level gateway of a DNS (DNS-ALG) of another home network specified by a redirector configured in the DNS-ALG of the home network, the redirector being dependent upon a global name of the other home network and a private address of the DNS server in the other home network.

The method may further comprise the steps of resolving a global domain name for the domain name request and forwarding a reply to a requesting host in response to the request, if the domain name request is determined not to be for the home network and the DNS-ALG of the home network does not have a redirector specified.

The method may further comprise the steps of, if the domain name request is determined to be for the home network, forwarding a reply to the requesting host from one of an external side DNS server and an internal side DNS server of the home network dependent upon whether the domain name request is from one of an internal host of the home network and the VPN, respectively.

In accordance with yet another aspect of the invention, there is provided a gateway for communicating between two or more home networks. The gateway comprises: at least one communications interface for transmitting and receiving data; a storage unit for storing data and instructions to be performed by a processing unit; and a processing unit coupled to the at least one communications interface and the storage unit, the processing unit programmed to transmit to a remote gateway via a tunnel of a virtual private network (VPN) a DNS setup packet comprising a global name of a home network and a private address of the DNS server in the home network; to receive from the remote gateway via the tunnel a DNS setup reply packet comprising a global name of another home network, and a private address of the DNS server in the other home network; and to configure an application level gateway of the DNS server (DNS-ALG) in the home network dependent upon the DNS setup reply packet to redirect DNS name requests for the global name of the other network through the aforementioned tunnel to the DNS server in the other network.

The processing unit may be programmed to extract from the DNS setup reply packet the global name of the other home network, and the private address of the DNS server in the other home network.

The processing unit may be programmed to resolve address conflicts between the home network and the other home network.

The processing unit may be programmed to generate a DNS setup packet comprising the global name of the home network, and the private address of the DNS server in the home network.

The global names of the home network and the other home network may be fully qualified domain names (FQDNs).

Configuring the DNS-ALG may comprise adding a redirect data structure in a configuration data structure of the DNS-ALG.

The gateway may further comprise a two-faced DNS system coupled to the DNS-ALG in the home network, the two-face DNS system comprising an internal side DNS server and an external side DNS server, the internal side DNS server resolving host names received via the VPN tunnel to corresponding private addresses.

The processing unit may be programmed to determine if a domain name in a domain name request received by the DNS-ALG in the home network is not for the home network; and if the domain name request is determined to not be for the home network, to forward the domain name request via the virtual private network (VPN) tunnel to an application level gateway of a DNS (DNS-ALG) of another home network specified by a redirector configured in the DNS-ALG of the home network.

The processing unit may be programmed to resolve a global domain name for the domain name request and to forward a reply to a requesting host in response to the request, if the domain name is determined not to be for the home network and the DNS-ALG of the home network does not have a redirector specified.

The processing unit may be programmed, if the domain name request is determined to be for the home network, to forward a reply to the requesting host from one of an external side DNS server and an internal side DNS server of the home network dependent upon whether the domain name request is from one of an internal host of the home network and the VPN, respectively.

### BRIEF DESCRIPTION OF THE DRAWINGS

A small number of embodiments are described hereinafter with reference to the drawings, in which:

FIG. 1 is a block diagram illustrating home-to-home communications;

FIG. 2 is a block diagram illustrating DNS-related services within a residential gateway;

FIG. 3 is a flow diagram illustrating a process of setting up name resolution redirectors during tunnel setup;

FIG. 4 is a diagram depicting signaling used in setting up re-directors of a DNS application level gateway;

FIG. 5 is a diagram depicting the forwarding of name requests for a VPN comprising three residential gateways;

FIG. 6 is a flow diagram illustrating a process of performing name resolution using a two-faced DNS;

FIG. 7 is an example of a home network that can be practiced in the system of FIG. 1;

FIG. 8 is a block diagram illustrating the architecture of a gateway with which embodiments of the invention may be practiced;

FIG. 9 is a flow diagram illustrating a process of setting up a redirector of domain name system (DNS) name requests; and

FIG. 10 is a flow diagram illustrating a process of resolving a domain name request in a domain name system (DNS).

### DETAILED DESCRIPTION OF THE PREFERRED EMBODIMENT OF THE INVENTION

Methods, systems, and gateways are disclosed for automatically setting up a redirector of domain name system (DNS) name requests for home-to-home network communications. In the following description, numerous specific details, including network interfaces, network protocols, and the like are set forth. However, from this disclosure, it will be apparent to those skilled in the art that modifications and/or substitutions may be made without departing from the scope and spirit of the invention. In other circumstances, specific details may be omitted so as not to obscure the invention. Where reference is made in any one or more of the accompanying drawings to steps and/or features, which have the same reference numerals, those steps and/or features have for the purposes of this description the same function(s) or operation(s), unless the contrary intention appears.

Overview

The embodiments of the invention provide a method for setting up a redirector of domain name system (DNS) name requests at home gateways during the process of setting up a tunnel between two home networks. This enables name requests for other connected homes to be routed across a tunnel to a corresponding gateway (GW) that is authoritative for the global name. The embodiments of the invention enable users to refer to hosts in remote homes using their global names, where hostnames resolve to private addresses instead of global addresses. Users are able to retain the use of their home's global domain name within a VPN.

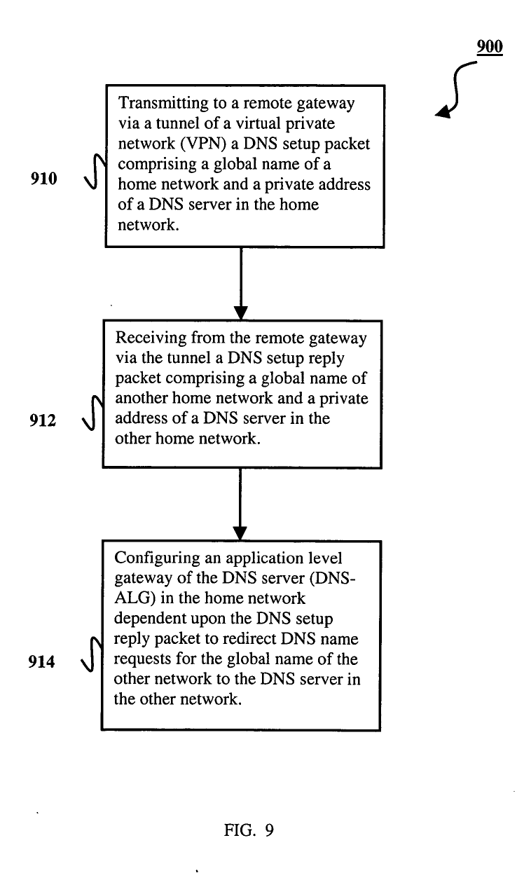

FIG. 9 is a flow diagram illustrating a process 900 of setting up a redirector of domain name system (DNS) name requests. In step 910, a DNS setup packet is transmitted to a remote gateway via a tunnel of a virtual private network (VPN). The DNS setup packet comprises a global name of a home network, and a private address of the DNS server in the home network. In step 912, a DNS setup reply packet is received from the remote gateway via the tunnel. The DNS setup reply packet comprises a global name of another home network, and a private address of the DNS server in the other home network. In step 914, an application level gateway of the DNS server (DNS-ALG) in the home network is configured dependent upon the DNS setup reply packet to redirect DNS name requests for the global name of the other network to the DNS server in the other network.

The embodiments of the invention are able to negotiate a domain name for use within a virtual private network (VPN) compatible with current DNS specifications in use on the Internet. The gateways (GWs) are authoritative for a portion of the home network's domain name, where the GW registers with the respective Internet Service Provider (ISP) to have the domain name in question delegated to the GW for resolution. The embodiments of the invention resolve internal hosts, rather than customer edges (CEs) and GWs, i.e., how host names are resolved after forming the VPN.

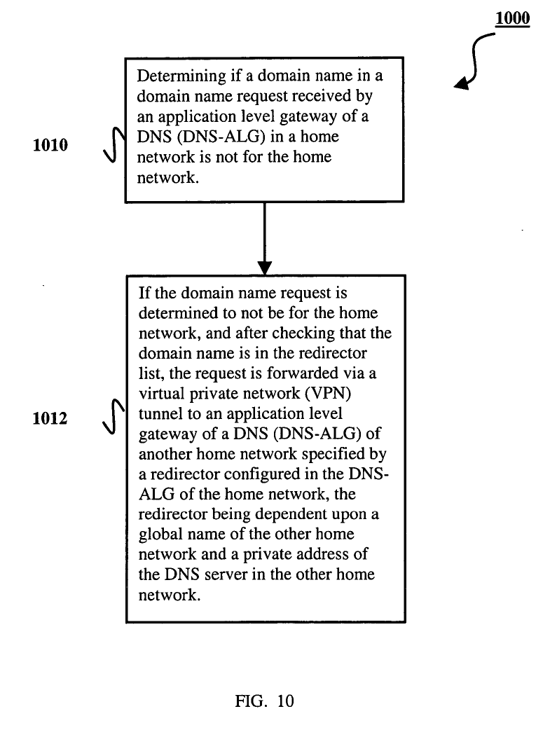

FIG. 10 is a flow diagram illustrating a process 1000 of resolving a domain name request in a domain name system (DNS). In step 1010, a determination is made if a domain name in a domain name request received by an application level gateway of a DNS (DNS-ALG) in a home network is not for the home network. In step 1012, if the domain name request is determined to not be for the home network, and the domain name is found in the redirector list, the domain name request is forwarded via a virtual private network (VPN) tunnel to an application level gateway of a DNS (DNS-ALG) of another home network specified by a redirector configured in the DNS-ALG of the home network. The redirector is dependent upon a global name of the other home network and a private address of the DNS server in the other home network.

The embodiments of the invention look up the domain name of a DNS request and send the request to an appropriate DNS server. However, the embodiments do not modify the destination address of the DNS request message. Instead, another DNS request is emitted to the matching network that is authoritative for the queried domain name. Furthermore, the embodiments of the invention involve a scheme for learning domain names that are part of a given VPN.

To set up a virtual private network, a local gateway (GW-local) connects to a remote gateway (or GW-remote) to form the VPN. After ensuring that the IP addresses in both home networks do not collide, the GW-local provides the GW-remote with its global home network name. The advantage of using the global home network name is that the fully qualified domain name (FQDN) itself is unique, and a name conflict is not likely to occur. An example of the joining process is as follows:
1) the GW-local passes its home network's global name “kwan.aol.com” to GW-remote; and
2) at this point, the setup process adds a redirect for “kwan.aol.com” in the DNS-ALG's configuration file at the GW-remote, informing the DNS-ALG at the GW-remote to send all requests for ?kwan.aol.com? to the DNS-ALG running at the GW-local.

One embodiment of the invention uses a two-faced DNS system, where the DNS requests from the VPN tunnel are forwarded to the DNS facing the internal side, i.e., one that resolves hostnames to their private addresses.

The embodiments of the invention provide a method of automatically linking name spaces of two or more homes if those homes merge to form a VPN. The embodiments of the invention, amongst other things, have application to home residential gateways. Passing domain names and DNS addresses during tunnel setup, setting up a DNS requests redirector, and installing gateway devices with a two-faced DNS enables names to be resolved in home-to-home communications.

Home-to-Home Communications

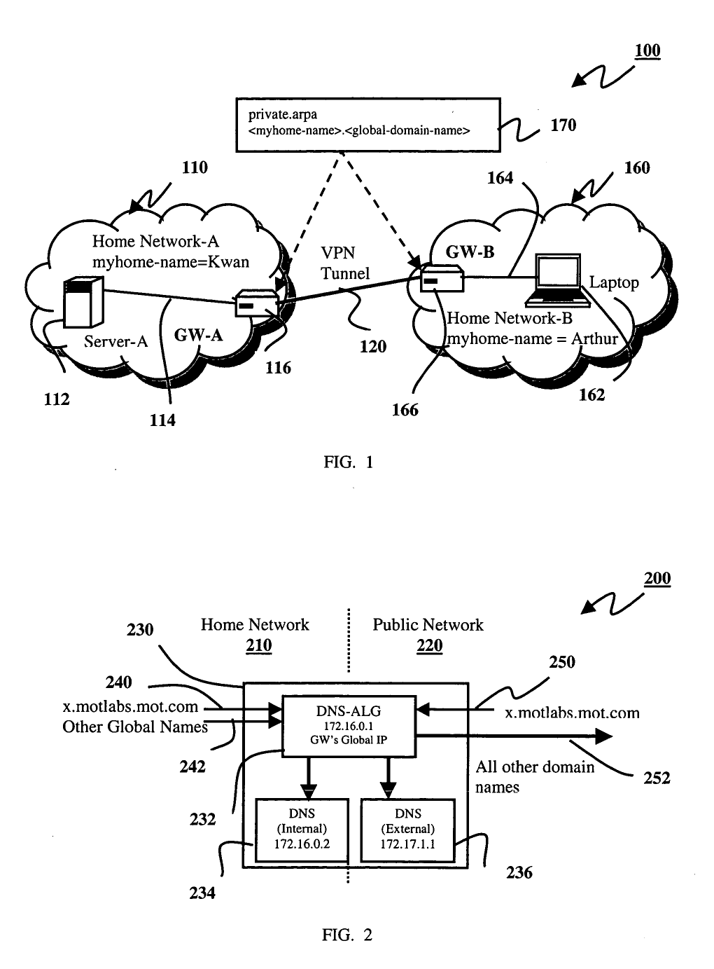

FIG. 1 is a high-level diagram illustrating communications between two or more home networks forming a VPN 100, with which embodiments of the invention may be practiced. Home network-A 110 and home network-B 160 are connected together to form a VPN. A VPN tunnel 120 conducts communications between the two networks 110, 160. The home network-A 110 comprises a server-A 112 coupled by suitable media 114 to a gateway-A (GW-A) 116. The server-A 112 may comprise one part of a local area network (LAN). For illustrative purposes only, the name of home network 110 (myhome-name) is “Kwan”. The other network 160 comprises a laptop computer 162 coupled by suitable media 164 to a gateway-B (GW-B) 166. Gateway-A 116 and gateway-B 166 are coupled together by the VPN tunnel 120. Each gateway 116, 166 has names 170, private.arpa and <myhome-name>.<global-domain-name>. For illustrative purposes only, the name of home network 160 (myhome-name) is “Arthur”. While only two home networks are depicted, it will be understood that the VPN 100 may comprise more than two home networks.

It will be readily apparent to those skilled in the art that, in the light of this disclosure, numerous variations and substitutions may be made. For example, in FIG. 1, the server-A and the laptop computer are directly connected to the respective residential gateway. Either or both of the connections may be directed to the residential gateway. Alternatively, the connection may be by way of an Ethernet network using appropriate media cables. Another possibility is that the communications path may be a wireless one, e.g., using IEEE 802.11a or IEEE 802.11b. Numerous other cable networks, wireless networks, or a combination of the two may be practiced. For example, a wireless device such as a PDA (e.g., a Palm Tungsten C) may be connected wirelessly to the server-A, which in turn may be coupled to the residential gateway by a cabled Ethernet network.

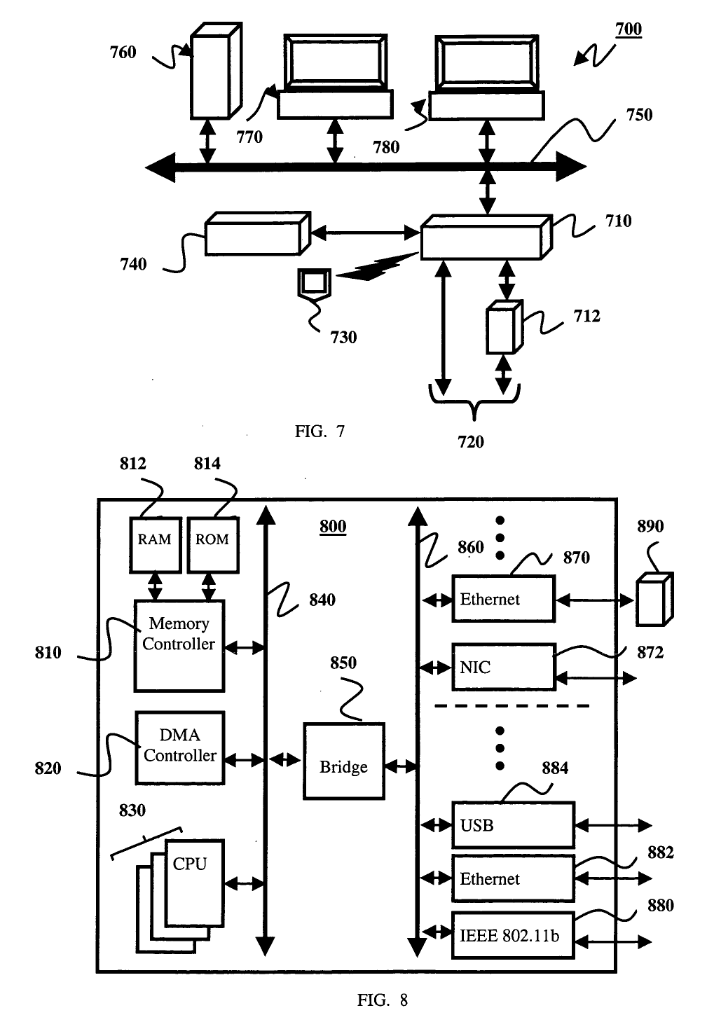

While FIG. 1 only shows a single host in each network, it will be readily appreciated by those skilled in the art that each home network may have two or more hosts. FIG. 7 is a block diagram of a home network 700 that may be practiced in FIG. 1 instead. The network 700 has a server 760 and two other computers 770 and 780 connected by an Ethernet network 750 to a gateway 710. The gateway 710 is also connected to a print server 740 and may be connected wirelessly to a PDA 730, for example. The gateway 710 may be connected by an appropriate communications interface directly, or by a modem 712 indirectly to the remote home network, as indicated by connections 720. The foregoing is merely an example of the configuration of a home network and is not meant to be limiting to the embodiments of the invention.

Referring again to FIG. 1, the home network VPN 100 is created in a piece-wise fashion, in which a gateway (GW) 116, 166 can only connect to an established VPN if itself is not already on the VPN. After successfully connecting to the VPN, the gateway can accept connections from other gateways that are not connected to the VPN yet. Further, gateways in the VPN may form a mesh network where each GW maintains a separate tunnel to other gateways in the VPN. The VPN is formed this way to avoid problems associated with the merging of two disparate VPNs.

Each host 112, 162 in a home network 110, 160 belongs to the domain “private.arpa” and possibly a global domain name, such as “myhome.x.motlabs.mot.com”, in accordance with box 170 of FIG. 1. As part of the gateway installation process, a user enters the name of the home, i.e., “myhome” in the example above. In FIG. 1, examples of the name of the home are given as “Kwan” and “Arthur”. The home's name is prepended to the home's global domain name, if one exists, and is used by external users to access hosts within the home 110, 160. Each host 112, 162 in a home network 110, 160 is configured to forward all its DNS requests to the gateway 116, 166 and is configured to be in the “private.arpa” domain.

Each gateway 116, 166 is equipped with a DNS (not shown in FIG. 1, but see FIG. 2) to answer requests from hosts that are internal and external to the home network. Also, each gateway is authoritative for the “private.arpa”. FIG. 2 illustrates the configuration 200 of a gateway 230 that may be practiced as gateway-A 116 and gateway-B 166 in FIG. 1. The gateway 230 bridges the home network 210 and an external public network 220, which may be the Internet, for example. The gateway 230 comprises a DNS application level gateway (ALG) 232 that is both a resolver and an IPv4/IPv6 communication enabler. The DNS-ALG 232 has the gateway's private IP address (e.g., 172.16.0.1) and possibly one or more ISP assigned global addresses.

The DNS-ALG may be implemented using a modification of Dan Bernstein's dnscache code, see http://cr.yp.to/djbdns.html for documentation and source code. One of dnscache's features is the ability to redirect requests for a given domain name to one or more IP addresses. The DNS-ALG 232 interfaces with an internal DNS 234 with its own IP address (e.g., 172.16.0.2) and an external DNS 236 with its own IP address (e.g., 172.17.1.1). To redirect DNS requests, a file may be created in the “server” directory with the global domain name (e.g., x.motlabs.mot.com), and the IP address of the servers that are authoritative for the domain are inserted into the file. The DNS-ALG 232 can receive the global domain name 240 (e.g., x.motlabs.mot.com) and other global names 242 from the home network 210. Further, the DNS-ALG 232 can receive the global domain name 250 and other domain names 252 from the external, global network 220.

FIG. 8 illustrates an example of the hardware architecture that may be used to implement the gateway 230 of FIG. 2 and the gateways 116, 166 of FIG. 1.

Example of Gateway Architecture

FIG. 8 is a block diagram illustrating the architecture of a gateway 800 with which the embodiments of the invention may be practiced. The gateway 800 comprises one or more central processing units (CPUs) 830, a memory controller 810, and storage units 812, 814. The memory controller 810 is coupled to the storage units 812, 814, which may be random access memory (RAM), read-only memory (ROM), and any of a number of storage technologies well known to those skilled in the art. The CPU 830 and the memory controller 810 are coupled together by a processor bus 840. A direct-memory-access (DMA) controller 820 may also be coupled to the bus 840. The DMA controller 820 enables the transfer of data to and from memory directly, without interruption of the CPU 820. As shown in FIG. 8, the processor bus 840 serves as the memory bus, but it will be well understood by those skilled in the art that separate processor and memory buses may be practiced. Software to implement functionality of the gateway may be embedded in the storage unit, including an operating system, drivers, firmware, and applications. The CPU 830 functions as the processing unit of the gateway, however, other devices and components may be used to implement the processing unit.

A bridge 850 interfaces the processor bus 840 and a peripheral bus 860, which typically operates at lower data rates than the processor bus 840. Various communications interfaces are in turn coupled to the peripheral bus 860. For example, one or more of several communications interfaces may be practiced to connect devices in the home network to the gateway. The gateway 800 has as examples of such interfaces an IEEE 802.11b wireless interface 880, an Ethernet interface 882, and a Universal Serial Bus (USB) interface 884. The foregoing are merely examples and other network interfaces may be practiced, such as a Token Ring interface, other wireless LAN interfaces, and an IEEE 1394 (Firewire) interface. For connections external to the home network, other interfaces may be practiced. For example, the gateway 800 may have a network interface card 872 for connection to another network. Alternatively, the gateway 800 may comprise an Ethernet interface 870, which can be connected to a suitable modem 890 (e.g., a broadband modem). Still other network interfaces may be practiced including ATM and DSL, as examples of a few. The processes of setting up a redirector of domain name system (DNS) name requests and of resolving a domain name request in a domain name system (DNS) may be implemented as software or computer programs carried out in conjunction with the processing unit and the storage unit(s) of the gateway.

While the gateway 800 has been depicted as a standalone device by itself, or in combination with a suitable modem, it will be well understood by those skilled in the art that the gateway may be implemented using a standard computer system with suitable software to implement the gateway functionality. Other variations may exist.

Setting Up Name Resolution Redirectors

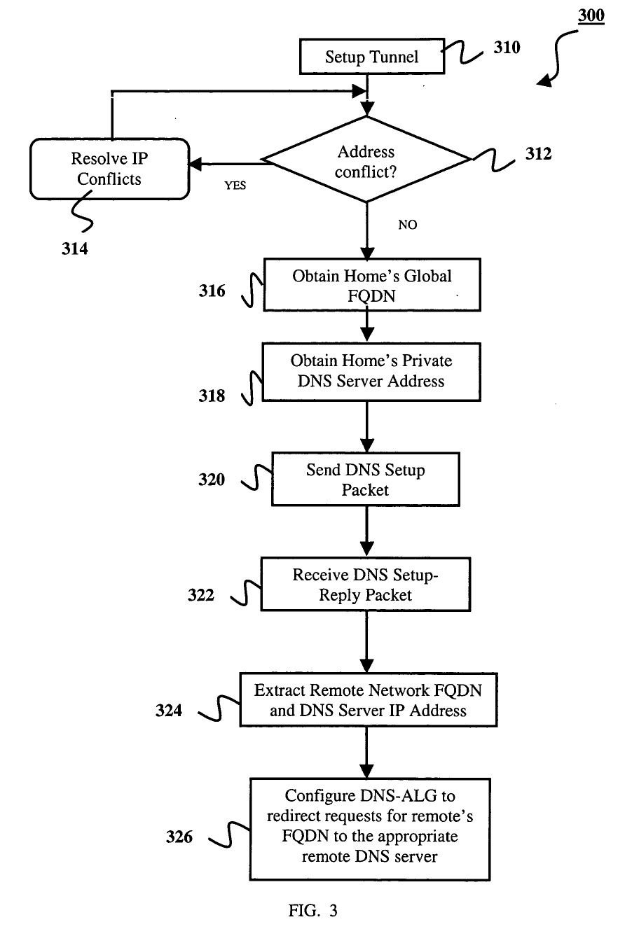

FIG. 3 is a flow diagram illustrating a process 300 of setting up name resolution redirectors during tunnel setup. Users retain the use of their home's global domain name within a VPN. In step 310, a tunnel is set up to establish a VPN. A local gateway (GW-local) connects to a remote GW (GW-remote) to form the VPN. In step 312, a check is made to determine if the IP addresses in both home networks conflict. If step 312 determines there is an address conflict (yes), processing continues at step 314, in which the IP address conflict is resolved. The conflict is resolved by the connecting home network renumbering all its internal subnets before trying to re-establish a tunnel to the GW-remote. Otherwise, if decision step 312 determines there is not a conflict (no), processing continues at step 316.

After ensuring that the IP addresses in both home networks do not conflict, in step 316, the global home network name is obtained from the GW-local (i.e., the GW-local provides the global home network name). The advantage of using the global home network name is that the fully qualified domain name (FQDN) itself is unique, and a name conflict is not likely to occur. In step 318, the home's private DNS server address is obtained from the GW-local. In step 320, a DNS setup packet is sent by the GW-local to the GW-remote. In step 322, the GW-local receives a DNS setup-reply packet from the GW-remote. In step 324, the remote network's FQDN, and the remote network's private DNS server address is extracted from the setup-reply packet. In step 326, the DNS-ALG of the GW-local is configured to redirect requests for the remote's FQDN to the appropriate remote DNS server.

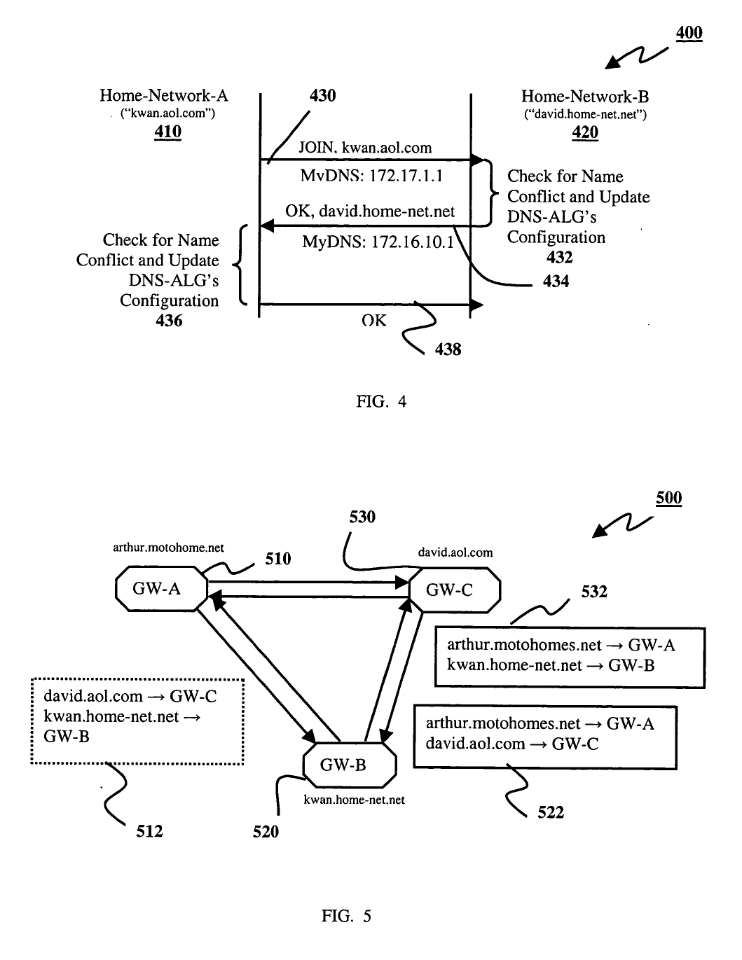

An example of a joining process 400 is depicted in FIG. 4. This drawing shows the signaling used in setting up re-directors of a DNS application level gateway. The gateway of home network-A 410 is the GW-local, and the network 410 has the home network's global name “kwan.aol.com”. The gateway of home network-B 420 is the GW-remote, and the network 420 has the home network's global name “david.home-net.net”. The GW-local passes its home network's global name “kwan.aol.com” to GW-remote, as indicated by arrow 430. This involves the statement “Join, kwan.aol.com” and the external DNS address “MyDNS: 172.17.1.1”. In step 432, the GW-remote checks for a name conflict, and if there is none, updates the DNS-ALG's configuration for the GW-remote. Thus, at this point, the setup process adds a redirect for “kwan.aol.com” in the DNS-ALG's configuration file. This tells the DNS-ALG at the GW-remote to send all requests for “kwan.aol.com” to the DNS-ALG running at the GW-local. The GW-remote sends “OK” (or acknowledgement) in the setup reply and provides its home network's global name “david.home-net.net” and “MyDNS: 172.16.10.1”. In step 436, the GW-local checks for a name conflict, and if there is none, updates its DNS-ALG's configuration for the GW-local. Arrow 438 indicates the “OK” (or acknowledgement) reply to the GW-remote.

Name Resolution

In each network, the hosts in the network are configured with network's DNS-ALG's address. Therefore, all DNS requests are sent to the DNS-ALG for resolution. In addition, using the embodiments of the invention, all other gateways that have established a tunnel to a GW record the private address of the DNS-ALG. For each DNS request, the DNS-ALG notes the incoming direction of the requests (i.e., the socket that a request came in from) and determines whether the request is from an internal host. If from an internal host, the request should be resolved using the “internal-facing” DNS server. The DNS-ALG then extracts the query name from the DNS request packet and determines whether the request can be resolved locally or externally. If the request matches a domain name in its “redirect” configuration directory, then the request is forwarded to the corresponding GW address.

FIG. 5 depicts the forwarding of name requests for a VPN 500 comprising three residential gateways 510, 520, 530. For example, each gateway 510, 520, 530 has a mapping 512, 522, 532 that tells the gateway where to forward requests to if a matching domain is found. The home network's global names for gateways 510, 520, 530 are “Arthur.motohome.net”, “kwan.home-net.net”, and “david.aol.com”, respectively. The gateway 510 has mapping 512: david.aol.com→GW-C; kwan.home-net.net→GW-B. The gateway 520 has mapping 522: arthur.motohomes.net→GW-A; david.aol.com→GW-C. The gateway 530 has mapping 532: arthur.motohomes.net→GW-A; kwan.home-net.net→GW-B.

Private and Global Address Resolution

For name resolution, each home network may comprise a two-faced DNS (or split DNS). In a split DNS system, the DNS returns different addresses depending on the direction of the query. One deployment scenario is to run two copies of the DNS server at different addresses. Each DNS server maintains the same hostnames, but each of these hostnames resolve to different A/AAAA RRs depending on which DNS server a query is directed at. The DNS-ALG in this embodiment is configured with the addresses of the DNS facing the private and global sides. Depending on where the DNS query originates, the DNS-ALG redirects the query to the appropriate DNS server.

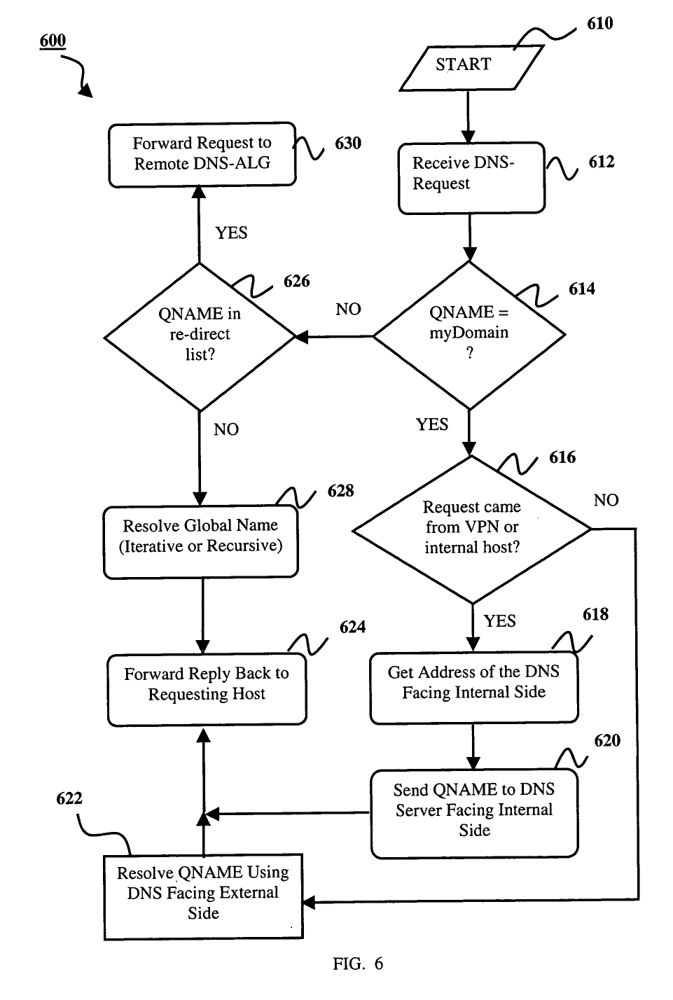

FIG. 6 shows a process 600 of how the DNS-ALG resolves a name query using this embodiment. Processing commences in step 610. In step 612, a DNS request is received by the DNS-ALG of the GW-local. In decision step 614, a check is made to determine if the queried domain name (QNAME) is myDomain (i.e., the relevant local domain name). If step 614 returns true (yes), processing continues at step 616. In decision step 616, a check is made to determine if the request came from a VPN or an internal host. If step 616 returns true (yes), processing continues at step 618. In step 618, the address of the DNS facing the internal side is gotten. In step 620, the queried domain name (QNAME) is sent to the DNS server facing the internal side. From step 620, the reply from the DNS server is forwarded to the requesting host.

If decision step 616 returns false (no), processing continues at step 622. In step 622, the queried domain name (QNAME) is resolved using the DNS facing the external side. Processing then continues at step 624, which forwards the reply back to the requesting host.

If decision step 614 returns false (no), processing continues at step 626. In decision step 626, a check is made to determine if the queried domain name (QNAME) is in the re-direct list of the DNS-ALG of GW-local. If decision step 626 returns true (yes), processing continues at step 630. The request is forwarded in step 630 to the remote DNS-ALG. This is done using the private address of the GW-remote. Otherwise, if decision step 626 returns false (no), processing continues in step 628. In step 628, the global name is resolved, iteratively or recursively according to RFC 1034, and RFC1035. Processing then continues in step 624, in which the reply is forwarded back to the requesting host.

The embodiments of the invention advantageously permit users to continue using a remote home's global domain name to access services within the remote home. However, the address returned differs depending on whether a tunnel to the remote home exists. If a tunnel exists, a query using the global domain name returns private addresses, resulting in traffic being routed across the VPN. On the other hand, if no tunnel exists, the query results in a global address. The GW may store a history of its previous tunnel connections, and if a query is made to a remote network that the GW previously has a tunnel to, a call-back may be provided to prompt the user to determine if the user wants to re-establish the tunnel. Otherwise, the GW may resolve the queried name through the Internet, hence return the global addresses associated with the queried name.

In the foregoing manner, a number of methods, systems, and gateways have been disclosed for automatically setting up a redirector of domain name system (DNS) name requests. Also, methods, systems, and gateways have been disclosed for resolving a domain name request in a domain name system (DNS). The detailed description provides preferred exemplary embodiments only, and is not intended to limit the scope, applicability, or configuration of the invention. Rather, the detailed description of the preferred exemplary embodiments provides those skilled in the art with enabling descriptions for implementing preferred exemplary embodiments of the invention. It should be understood that various changes may be made in the function and arrangement of elements without departing from the spirit and scope of the invention as set forth in the appended claims.

1. A method of automatically setting up a redirector of domain name system (DNS) name requests, said method comprising the steps of:
transmitting to a remote gateway via a tunnel of a virtual private network (VPN) a DNS setup packet comprising a global name of a home network, and a private address of a DNS server in said home network;
receiving from said remote gateway via said tunnel a DNS setup reply packet comprising a global name of another home network, and a private address of a DNS server in said other home network; and
configuring an application level gateway of said DNS server (DNS-ALG) in said home network dependent upon said DNS setup reply packet to redirect DNS name requests for said global name of said other network to said DNS server in said other network.

2. The method according to claim 1, further comprising the step of extracting from said DNS setup reply packet said global name of said other home network, and said private address of said DNS server in said other home network.

3. The method according to claim 1, further comprising the step of resolving address conflicts between said home network and said other home network.

4. The method according to claim 1, further comprising the step of generating a DNS setup packet comprising said global name of said home network, and said private address of said DNS server in said home network.

5. The method according to claim 1, wherein said global names of said home network and said other home network are fully qualified domain names (FQDNs).

6. The method according to claim 1, wherein said configuring step comprises adding a redirect data structure in a configuration data structure of said DNS-ALG.

7. The method according to claim 1, further comprising the step of using a two-faced DNS system coupled to said DNS-ALG in said home network, said two-face DNS system comprising an internal side DNS server and an external side DNS server, said internal side DNS server resolving host names received via said VPN tunnel to corresponding private addresses.

8. A method of resolving a domain name request in a domain name system (DNS), said method comprising the steps of:
determining if a domain name in a domain name request received by an application level gateway of a DNS (DNS-ALG) in a home network is not for said home network; and
if said domain name request is determined to not be for said home network, forwarding said domain name request via a virtual private network (VPN) tunnel to an application level gateway of a DNS (DNS-ALG) of another home network specified by a redirector configured in said DNS-ALG of said home network, said redirector being dependent upon a global name of said other home network and a private address of said DNS server in said other home network.

9. The method according to claim 8, further comprising the steps of resolving a global domain name for said domain name request and forwarding a reply to a requesting host in response to said request, if said domain name request is determined not to be for said home network and said DNS-ALG of said home network does not have a redirector specified.

10. The method according to claim 8, further comprising the steps of, if said domain name request is determined to be for said home network, forwarding a reply to said requesting host from one of an external side DNS server and an internal side DNS server of said home network dependent upon whether the domain name request is from one of an internal host of said home network and said VPN, respectively.

11. A gateway for communicating between two or more home networks, comprising:
at least one communications interface for transmitting and receiving data;
a storage unit for storing data and instructions to be performed by a processing unit; and
a processing unit coupled to said at least one communications interface and said storage unit, said processing unit is programmed to:
transmit to a remote gateway via a tunnel of a virtual private network (VPN) a DNS setup packet comprising a global name of a home network, and a private address of a DNS server in said home network;
to receive from said remote gateway via said tunnel a DNS setup reply packet comprising a global name of another home network, and a private address of a DNS server in said other home network; and
to configure an application level gateway of said DNS server (DNS-ALG) in said home network dependent upon said DNS setup reply packet to redirect DNS name requests for said global name of said other network to said DNS server in said other network.

12. The gateway according to claim 11, wherein said processing unit is programmed to extract from said DNS setup reply packet said global name of said other home network and said private address of said DNS server in said other home network.

13. The gateway according to claim 11, wherein said processing unit is programmed to resolve address conflicts between said home network and said other home network.

14. The gateway according to claim 11, wherein said processing unit is programmed to generate a DNS setup packet comprising said global name of said home network and said private address of said DNS server in said home network.

15. The gateway according to claim 11, wherein said global names of said home network and said other home network are fully qualified domain names (FQDNs).

16. The gateway according to claim 11, wherein configuring said DNS-ALG comprises adding a redirect data structure in a configuration data structure of said DNS-ALG.

17. The gateway according to claim 11, further comprising a two-faced DNS system coupled to said DNS-ALG in said home network, said two-face DNS system comprising an internal side DNS server and an external side DNS server, said internal side DNS server resolving host names received via said VPN tunnel to corresponding private addresses.

18. The gateway according to claim 11, wherein said processing unit is programmed:
to determine if a domain name in a domain name request received by said DNS-ALG in said home network is not for said home network; and
if said domain name request is determined to not be for said home network, to forward said domain name request via said virtual private network (VPN) tunnel to an application level gateway of a DNS (DNS-ALG) of another home network specified by a redirector configured in said DNS-ALG of said home network.

19. The gateway according to claim 18, wherein said processing unit is programmed to resolve a global domain name for said domain name request and to forward a reply to a requesting host in response to said request, if said domain name is determined note to be for said home network and said DNS-ALG of said home network does not have a redirector specified.

20. The gateway according to claim 18, wherein said processing unit is programmed, if said domain name request is determined to be for said home network, to forward a reply to said requesting host from one of an external side DNS server and an internal side DNS server of said home network dependent upon whether the domain name request is from one of an internal host of said home network and said VPN, respectively.
